(19) United States
(12) Patent Application Publication
(10) Pub. No.: US 2009/0004030 A1
(43) Pub. Date: Jan. 1, 2009

(54) COMPRESSOR SWASH PLATE AND METHOD OF MANUFACTURING THE SAME

(75) Inventors: Takahiro Sugioka, Aichi-ken (JP); Atsushi Saito, Aichi-ken (JP); Takayuki Kato, Aichi-ken (JP); Tetsuyoshi Wada, Tokyo (JP); Mitsumasa Sasaki, Tokyo (JP); Hidetada Mima, Tokyo (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignees: KABUSHIKI KAISHA TOYOTA JIDOSHOKKI, Aichi-ken (JP); SULZER METCO (JAPAN) LTD., Tokyo (JP)

(21) Appl. No.: 12/104,539

(22) Filed: Apr. 17, 2008

(30) Foreign Application Priority Data
Apr. 25, 2007 (JP) 2007-115567

(51) Int. Cl. F04B 27/08; B23P 17/00

(52) U.S. Cl. 417/269; 29/527.4

(57) ABSTRACT

The invention provides a compressor swash plate which is lead-free and is able to demonstrate a superior durability. A compressor swash plate in the invention includes a base member and a sliding layer being formed on the surface of the base member and constituting at least a sliding surface for allowing a shoe to slide thereon. The sliding layer is formed by thermal spraying Cu-based-MnS by HVOF thermal spraying method. A method of manufacturing the compressor swash plate according to the invention includes a step of thermal spraying powder formed of Cu-based-MnS onto the base member by the HVOF thermal spraying method to form the sliding layer which constitutes at least the sliding surface which allows the shoe to slide thereon on the base member. More specifically, the Cu-based-MnS is Cu-Ni-MnS.

### CROSS-REFERENCE TO RELATED APPLICATION

This application claims the benefit of priority to Japanese Patent Application No. 2007-115567, filed on Apr. 25, 2007, the contents of which are hereby incorporated herein by reference.

### BACKGROUND OF THE INVENTION

The present invention relates to a compressor swash plate and a method of manufacturing the same.

Compressor swash plates in the related art are disclosed in JP-A-11-193780and JP-A-2001-234859. These compressor swash plates each include a base member and a sliding layer which is formed on the surface of the base member and constitutes a sliding surface for allowing a shoe to slide thereon.

JP-A-11-193780 discloses the compressor swash plate in which the base member is formed of iron-based material such as Nodular graphite cast iron (FCD) or bearing steel (SUJ2), and the sliding layer is formed by thermal spraying Cu-Sn-Pb is disclosed. The sliding layer is formed with a lubricating layer formed of MoS₂ and polyamide-imide thereon.

JP-A-2001-234859 discloses the compressor swash plate in which the base member is formed of iron-based material, and the sliding layer is formed of Al-Si deposited by frictional heat. This compressor swash plate is formed with two such sliding layers.

The compressor swash plate as described above is used for the swash-plate-type compressor. The swash-plate-type compressor includes housings formed in the interior thereof with cylinder bores, a crank chamber, an suction chamber and a discharge chamber; pistons stored in the cylinder bores so as to be capable of reciprocating and defining compression chambers in the cylinder bores; a drive shaft driven by an external drive source and rotatably supported by the housings; and a swash plate provided in the crank chamber for transforming the rotational movement of the drive shaft to the reciprocating movement of the pistons via pairs of shoes which come into contact with the front and rear surfaces of its own. The general swash plate is a single unit, and is capable of rotating with the drive shaft in a state in which the front and rear surfaces of its own are inclined with respect to the drive shaft. On the other hand, the each shoe is formed into a substantially semispherical shape, and substantially flat surfaces of the shoes come into contact with the front and rear surfaces of the swash plate.

In the swash-plate-type compressor configured as described above, when the drive shaft rotates by the external drive source, the swash plate also rotates, and the pistons reciprocate in the cylinder bores, respectively via the shoes. Accordingly, the swash-plate-type compressor sucks refrigerant gas from the suction chamber to the compression chambers, compresses the refrigerant gas in the compression chambers, and discharges into the discharge chamber.

The swash-plate-type compressor as described above is used with an evaporator, an expansion valve, a condenser and a piping to constitute a refrigerating circuit for vehicles, so that a cabin or the like is air-conditioned.

In recent years, reduction of usage of lead is requested in the field of manufacturing mechanical parts from the reasons of environment. Therefore, as regards the swash-plate-type compressors in various types, a change from above described Cu-Sn-Pb which contains lead to a lead-free material as a material to form the sliding layer is desired.

However, although the above-described Al-Si does not contain lead and demonstrates a certain level of slidability, when there is little or no lubrication oil, the slidability is lower than Cu-Sn-Pb. According to the inspection by the inventors, it is the same with Cu-Sn-Al-Si. Therefore, when the sliding layer is formed on the base member using such alloy as a material, portions between the swash plate and the shoes are liable to burn, so that the durability of the swash-plate-type compressor may be deteriorated.

### BRIEF SUMMARY OF THE INVENTION

In view of such circumstances, it is an object of the invention to provide a compressor swash plate which is lead-free and is able to demonstrate a superior durability.

The inventors have devoted ourselves to study for finding a material which is lead-free and demonstrates a desirable slidability as a material of sliding layers. Consequently, the inventors found that the siding layer formed by thermal spraying Cu-based-MnS by HVOF (High Velocity Oxygen Fuel) thermal spraying method is able to achieve the above-described object.

In other words, the compressor swash plate according to the invention is characterized by having a base member and a sliding layer being formed on the surface of the base member and constituting at least a sliding surface for allowing a shoe to slide thereon, wherein the sliding layer is formed by thermal spraying Cu-based-MnS by the HVOF thermal spraying method.

A method of manufacturing a compressor swash plate according to the invention is characterized by including a step of thermal spraying powder formed of Cu-based-MnS onto a base member by the HVOF thermal spraying method to form a sliding layer which constitutes at least a sliding surface which allows a shoe to slide thereon on the base member.

Other aspects and advantages of the invention will be apparent from embodiments disclosed in the attached drawings, illustrations exemplified therein, and the concept of the invention.

### BRIEF DESCRIPTION OF THE SEVERAL VIEWS OF THE DRAWINGS

The invention will be described in more detail along with the concept and advantages thereof by referring to the attached drawings and the detailed description of the preferred embodiments below.

FIG. 1 is a vertical cross-section of a swash-plate-type compressor according to Embodiment 1;

FIG. 2 is an enlarged vertical cross-sectional view showing a principal portion of the swash-plate-type compressor according to Embodiment 1;

FIG. 3 is a cross-sectional view showing a method of manufacturing the compressor swash plate according to Embodiment 1; and

FIG. 4 is a schematic pattern diagram showing a method of measuring a burning load between a swash plate sample and a shoe.

### DETAILED DESCRIPTION OF THE PREFERRED EMBODIMENTS

### Embodiment 1

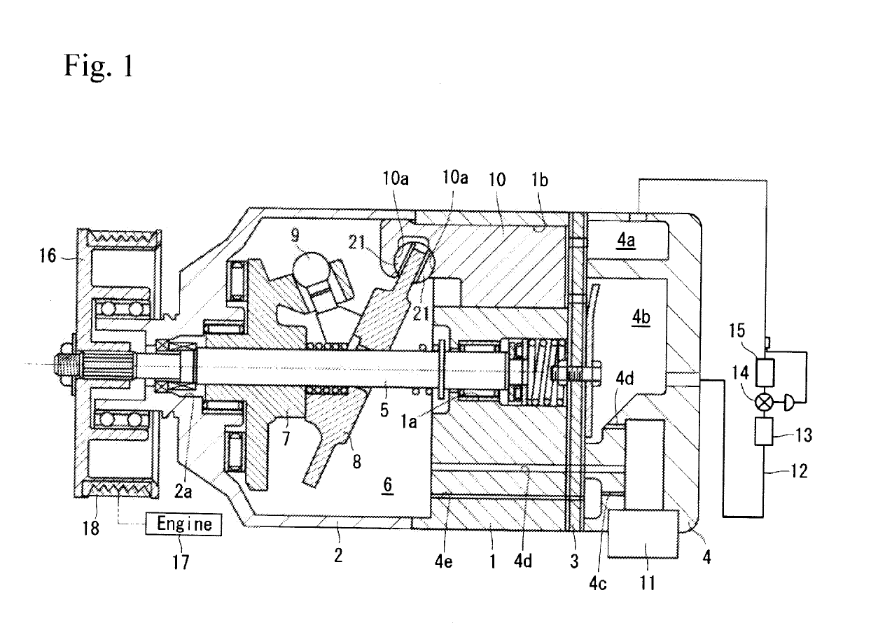

First of all, a variable capacity swash-plate-type compressor in which a compressor swash plate according to Embodiment 1 is employed will be described. As shown in FIG. 1, in the compressor, a front housing 2 is joined to the front end of a cylinder block 1, and a rear housing 4 is joined to the rear end of the cylinder block 1 via a valve unit 3. The cylinder block 1 and the front housing 2 are formed with shaft holes 1a, 2a extending therethrough in the axial direction, and a drive shaft 5 is rotatably supported by the shaft holes 1a, 2a via bearing devices or the like, respectively. The left side in FIG. 1 corresponds to the front side, and the right side corresponds to the rear side.

The interior of the front housing 2 functions as a crank chamber 6. In the crank chamber 6, a lug plate 7 is fixed to the drive shaft 5 via the bearing device with respect to the front housing 2. A swash plate 8 is provided behind the lug plate 7 in the crank chamber 6. The swash plate 8 is penetrated by the drive shaft 5 therethrough and, in this state, the angle of inclination changes by a link mechanism 9 provided between the lug plate 7 and the swash plate 8.

The cylinder block 1 is formed with a plurality of cylinder bores 1b extending concentrically therethrough in the axial direction. A single headed piston 10 is stored in each cylinder bore 1b so as to be capable of reciprocating therein. The each piston 10 has a neck portion on the crank chamber 6 side, and the neck portion of the each piston 10 is formed with receiving seats 10a each depressed with a spherical surface so as to oppose to each other.

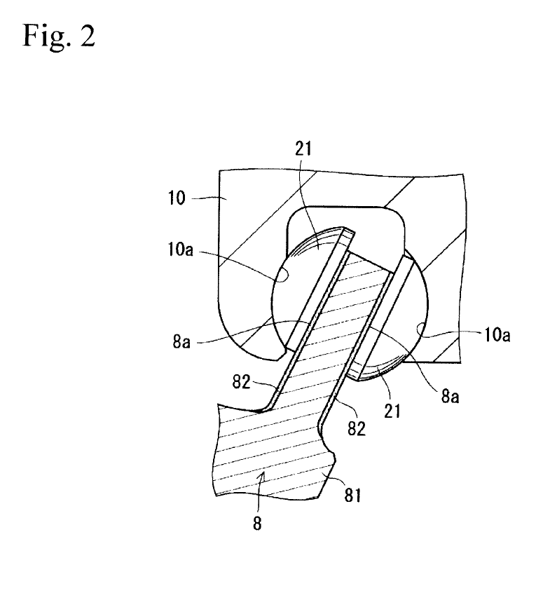

A pair of front and rear shoes 21 are provided between the swash plate 8 and the respective pistons 10. As shown in FIG. 2, the swash plate 8 includes a base member 81, and sliding layers 82 and 82 formed on the peripheral edges of the front and rear surfaces of the base member 81. The base member 81 is formed of iron-based material such as FCD, SUJ2. The sliding layer 82 is formed by thermal spraying Cu-31Ni-6.4MnS by HVOF thermal spraying method.

The surfaces of the sliding layers 82 and 82 include flat sliding surfaces 8a and 8a which allow the shoes 21 to slide thereon, respectively. It is also possible to form a lubricating layer formed of MoS₂ and polyamide-imide on the sliding layer 82. In this case, the sliding layer 82 and the lubricating layer constitute the sliding surfaces 8a and 8a. The shoes 21 are each formed into a substantially semispherical shape, and the semispherical surfaces of the shoes 21 come into contact with the receiving seats 10a of the piston 10, and the substantially flat surfaces thereof come into contact with the sliding surfaces 8a and 8a of the swash plate 8.

As shown in FIG. 1, an suction chamber 4a and a discharge chamber 4b is formed in the rear housing 4. The cylinder bores 1b are able to communicate with the suction chamber 4a via an suction valve mechanism of a valve unit 3, and are able to communicate with the discharge chamber 4b via a discharge valve mechanism of the valve unit 3.

A capacity control valve 11 is stored in the rear housing 4. The capacity control valve 11 communicates with the suction chamber 4a via a detection path 4c, and communicates the discharge chamber 4b and the crank chamber 6 by a gas-supply path 4d. The capacity control valve 11 changes the opening of the gas-supply path 4d by detecting the pressure of the suction chamber 4a, and changes the discharge capacity of the compressor. The crank chamber 6 and the suction chamber 4a are communicated by a gas-extraction path 4e. A condenser 13, an expansion valve 14 and an evaporator 15 are connected to the discharge chamber 4b via a piping 12, and the evaporator 15 is connected to the suction chamber 4a via the piping 12.

A pulley 16 is provided at the front end of the front housing 2 so as to rotatable with the bearing device, and the pulley 16 is fixed to the drive shaft 5. A belt 18, which is rotated by an engine 17 is wound around the pulley 16.

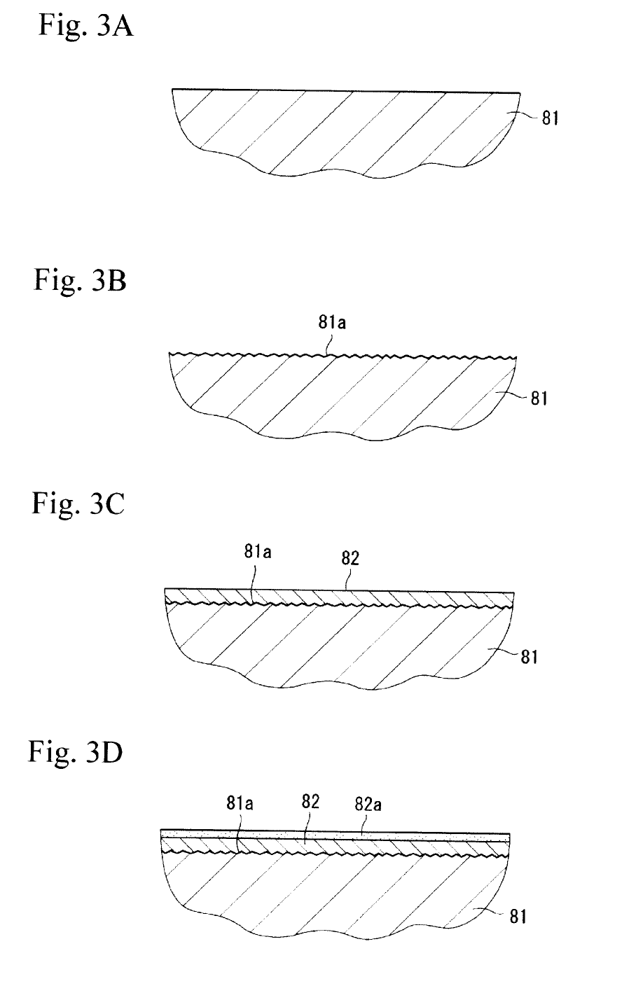

The swash plate 8 is manufactured as follows. As shown in FIG. 3A, the base member 81 formed of the iron-based material such as FCD or SUJ2 is prepared by casting or machining. Then, as shown in FIG. 3B, the peripheral edges 81a on the front and rear surfaces of the base member 81 is roughened by sand blast or the like to achieve an average roughness of 20 to 40 μm.

On the other hand, powder formed of Cu-31Ni-6.4Mns is prepared. Then the powder and DJ-type HVOF thermal spraying system manufactured by Sulzer Metco are used to spray the peripheral edges 81a of the base member 81 by the HVOF thermal spraying method. The conditions of the HVOF thermal spraying method are as follows.

Oxygen supply pressure: 150 psi

Fuel (Kerosene) supply pressure: 80 psi

Carrier gas (Nitrogen) supply pressure: 150 psi

Air supply pressure: 75 psi

In this manner, a thermal spraying layer is formed as shown in FIG. 3C. Since the thermal spraying layer after sprayed thermally has roughness of about 8 μm Ra on the surface thereof, the surface is polished until the roughness is reduced to about 0.05 μm Ra. The sliding layer 82 is formed in this manner. As shown in FIG. 3D, a lubricating layer 82a formed of MoS₂ and polyamide-imide is formed on the sliding layer 82 as needed.

In the compressor configured as described above, the swash plate 8 rotates synchronously with the rotation of the drive shaft 5 shown in FIG. 1, and the pistons 10 reciprocate in the cylinder bores 1b via the shoes 21. Accordingly, the capacity of a compression chamber formed on the head side of the piston 10 is changed. Consequently, the refrigerant gas gas in the suction chamber 4a is taken into the compression chamber and is compressed therein, and then discharged into the discharge chamber 4b. In this manner, refrigerating action is carried out in a refrigerating circuit composed of the compressor, the condenser 13, the expansion valve 14 and the evaporator 15. During this period, the substantially flat surfaces of the shoes 21 come into sliding contact with the sliding surfaces 8a of the swash plate 8, and the semispherical surfaces thereof come into sliding contact with the receiving seats 10a of the piston 10.

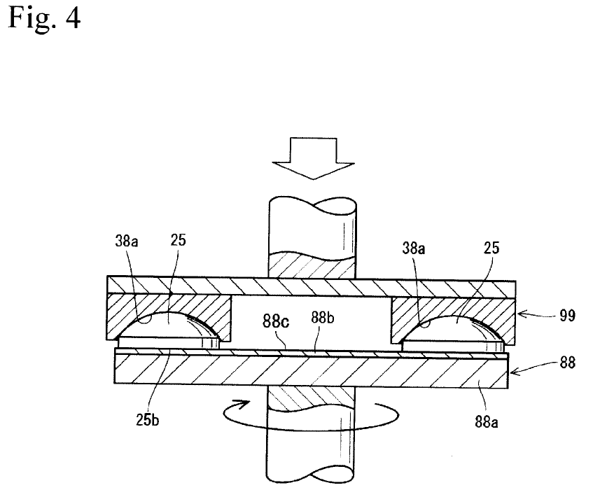

In order to evaluate the durability of the compressor in Embodiment 1, an experiment was conducted as follows. As shown in FIG. 4, a swash plate sample 88 which is an imitation of the swash plate 8 and shoes 25 were prepared. The swash plate sample 88 was obtained by forming a sliding layer 88b on the upper surface of a base member 88a which was the same type as the swash plate 8. The surface of the sliding layer 88b constitutes a flat sliding surface 88c for allowing the each shoe 25 slide. The shoes 25 were placed so that the substantially flat surfaces thereof come into contact with the sliding layer 88b of the swash plate sample 88. Then, the shoes 25 are pressed against the swash plate sample 88 at a predetermined load by a pressing jig 99 on which shoe seats 38a in the form of depressions corresponding to the semispherical surfaces of the shoes 25 are formed thereon. In this manner, the swash plate sample 88 was rotated at about a rotational speed of 1000 rpm in a state in which the swash plate sample 88 and the shoe 25 were in contact and the approximate load value which causes the burning was evaluated.

The sliding layer 88b of the swash plate sample 88 in Embodiment 1 is formed by thermal spraying Cu-31Ni-6.4Mns by HVOF thermal spraying method. The sliding layer 88b of the swash plate sample 88 in Comparative Embodiment 1 is formed by thermal spraying Cu-15Sn-30Al-20Si by a general thermal spraying method. The sliding layer 88b of the swash plate sample 88 in Comparative Example 2 is formed of Al-40Si sprayed in the same manner. The sliding layer 88b of the swash plate sample 88 in Comparative Example 3 is formed by thermal spraying Cu-10Sn-10Pb in a general thermal splaying method. A lubricating layer of MoS₂ and polyamide-imide is formed on the each sliding layer 88b in Embodiment 1 and Comparative Examples 1 to 3.

The evaluations are made for the case in which the shoe 25 formed of SUJ2 is used and for the case in which a plated layer formed of Ni is applied on the base member of the shoe formed of aluminum-based material. The lubricating condition is “No lubrication”. The results are shown in Table 1.

| | | Sliding movement | Sliding movement |
|---|---|---|---|
| | | with respect to | with respect to |
| | | iron—based shoe | aluminum—based |
| | Composition | (kgf) | shoe (kgf) |
| Embodiment 1 | Cu—Ni—MnS | 100 | 120 |
| Comparative | Cu—Sn—Al—Si | 60 | 70 |
| Example 1 | | | |
| Comparative | Al—Si | 60 | 60 |
| Example 2 | | | |
| Comparative | Cu—Sn—Pb | 80 | 100 |
| Example 3 | | | |

As shown in Table 1, it was found that the swash plate sample 88 in Embodiment 1 demonstrates a higher burning resistant load with respect to the iron-based and aluminum-based shoes 25 in comparison with the swash plate sample 88 in Comparative Examples 1 to 3.

Therefore, the swash plate 8, which is the same as the swash plate sample 88 in Embodiment 1, is lead-free, and demonstrates a superior durability. Therefore, it was found that the swash-plate-type compressor in Embodiment 1 demonstrates a superior environmental performance and a long life.

The invention has been described in conjunction with Embodiment 1, it is needless to say that the invention is not limited to Embodiment 1 shown above, and modifications may be made without departing the scope of the invention as needed.

According to the results of experiments conducted by the inventors, the compressor swash plate in the invention demonstrates a high burning-resistant load with respect to the shoe formed of iron-based materials or aluminum-based materials. The swash plate in the invention demonstrates a higher burning-resistant load than not only the swash plate having the sliding layer formed of Al-Si in the related art, but also the swash plate having the sliding layer formed of Cu-Sn-Pb in the related art. A lubricating layer formed of MoS₂ and polyamide-imide maybe formed on the sliding layer.

For example, JP-A-57-198245 and JP-A-2005-133130 describe that Cu-based-MnS is a material superior in slidability and abrasion resistance. However, there is no description saying that Cu-based-MnS is able to be used for the compressor swash plate and no disclosure of thermal spraying the material by the HVOF thermal spraying method.

The inventors consider the reason why the sliding layer formed by thermal spraying Cu-based-MnS by the HVOF thermal spraying method demonstrates slidability suitable for the compressor swash plate as follows. In the process of the HVOF thermal spraying method, a high-pressure oxygen and fuel mixture is burned in a combustion chamber and ejected out to the atmosphere while squeezing the burning flame by a nozzle. Accordingly, the flame is subjected to an abrupt gas expansion at a moment when it is ejected out to the atmosphere and be a supersonic jet flame. When the powder formed of Cu-based-MnS is used in the HVOF thermal spraying method, the power accelerated by a high accelerating energy is considered to keep the superior slidability and abrasion resistance in terms of components with little oxidation or fatigue while being kept in a semi-fused state with moderately solid portion contained therein so that a high-density and precise sliding layer under a high adhesiveness is formed.

Therefore, the compressor swash plate in the invention is lead-free and demonstrates superior durability. Therefore, the swash-plate-type compressor employing this swash plate demonstrates a superior environmental performance and realizes a long life.

The base member may be formed of iron-based materials such as FCD or SUJ2. The surface of the base member is preferably roughened. According to the understanding of the inventors, the average roughness of the surface of the base member is preferably 20 to 40 μm.

The sliding layer is formed on the surface of the base member, and constitutes the sliding surface on which the shoe slides. The sliding layer may configure a portion other than the sliding surface, that is, other portions of the swash plate. According to the understanding of the inventors, the thickness of the sliding layer is preferably 30 to 200 μm. According to the results of experiments conducted by the inventors, the sliding layer according to the invention is Hv150 to 350.

The shoe, which is the counterpart of the swash plate, may be formed of the iron-based material such as SUJ2 or the aluminum-based material. According to the results of experiments conducted by the inventors, the swash plate in the invention demonstrates a significant effect when the shoe is formed of the iron-based material such as SUJ2. The shoe formed of the aluminum-based material may have a plated layer formed of Ni on the surface thereof.

The swash-plate-type compressor may use CO₂ refrigerant gas as well as general refrigerant gas such as R134a. In particular, when CO₂is used as the refrigerant gas, the effect of the invention is remarkably enjoyed. It is because CO₂ as the refrigerant gas achieves a very high pressure on the order of 15 MPa at time of compression and a compression reaction force applied from the piston to the swash plate via the shoes is also very high. CO₂ as the refrigerant gas has a very low in lubricating capability in comparison with other general refrigerant gas even though the lubricating component is added.

The compressor swash plate in the invention may be employed in various swash-plate-type compressors using the swash plate. For example, the compressor swash plate in the invention may be employed not only in general swash-plate-type compressors having a single swash plate, but also in the swash-plate-type compressors employing a first swash plate rotatable with the drive shaft and a second swash plate supported so as to be capable of rotating relatively with respect to the first swash plate. In the case of the swash-plate-type compressor having the single swash plate, the compressor swash plate in the invention may be applied to a swash plate which changes in angle of inclination with respect to the drive shaft, and may be employed to a swash plate which does not change in angle of inclination with respect to the drive shaft. In the case of the swash-plate-type compressor having the swash plate including the first swash plate and the second swash plate, the compressor swash plate in the invention may be employed as the second swash plate.

Cu-based-MnS is an alloy containing MnS in Cu as a base component. The inventors confirmed the effect of the invention when Cu-based-MnS is Cu-Ni-MnS. According to the understanding of the inventors, Cu-Ni-MnS preferably composed of by 40 to 70% Cu, 20 to 40% Ni, and 1 to 10% MnS in mass. When it contains less than40% Cu in mass, Cu alloy phase is reduced, which results in fragility, and when it contains more than 70% Cu in mass, the strength is lowered. When it contains less than 20% Ni in mass, the amount of dissolution of MnS is lowered, and when it contains more than 40% Ni in mass, the Cu alloy phase is reduced, which results in fragility. When it contains less than 1% MnS in mass, it is dissolved by Cu alloy, which results in decrease in deposited amount, so that the effect of improvement of sliding property is lowered. It contains more than 10% MnS in mass, the size of sludge of MnS increases, which results in segregation and poor distribution, so that fragility increases.

The invention is available for the swash-plate-type compressor.

1. A compressor swash plate characterized by comprising:
a base member and a sliding layer being formed on the surface of the base member and constituting at least a sliding surface for allowing a shoe to slide thereon,
wherein the sliding layer is formed by thermal spraying Cu-based-MnS by HVOF thermal spraying method.

2. The compressor swash plate according to claim 1, characterized in that the Cu-based-MnS is Cu-Ni-MnS.

3. The compressor swash plate according to claim 2, characterized in that the Cu-Ni-MnS is composed of Cu by 40 to 70 mass %, Ni by 20 to 40 mass %, and MnS by 1 to 10 mass %.

4. A method of manufacturing a compressor swash plate characterized by comprising:
a step of thermal spraying powder formed of Cu-based-MnS onto a base member by HVOF thermal spraying method to form a sliding layer which constitutes at least a sliding surface which allows a shoe to slide thereon on the base member.
